(19) United States
(12) Patent Application Publication
(10) Pub. No.: US 2002/0100419 A1
(43) Pub. Date: Aug. 1, 2002

(54) Film treatment apparatus and method

(75) Inventor: Shinji Nagashima, Kumamoto (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOKYO ELECTRON LIMITED, Tokyo (JP)

(21) Appl. No.: 10/046,312

(22) Filed: Jan. 16, 2002

(30) Foreign Application Priority Data
Jan. 30, 2001 (JP) 2001-022261

(51) Int. Cl. B05D 3/04

(52) U.S. Cl. 118/722; 427/337; 118/500

(57) ABSTRACT

An object of the present invention is to stably supply a treatment chamber with a treatment gas with a prescribed composition. A spin on dielectric (SOD) system includes a film treatment apparatus of the present invention which comprises, for forming an interlayer insulating film, a treatment chamber for placing a wafer W, a first mass flow controller for NH₃ gas, a second mass flow controller for N₂ gas with a prescribed water vapor, thereby supplying the treatment chamber with a gas of a prescribed composition.

### BACKGROUND OF THE INVENTION

1. Field of the Invention

The present invention relates to an apparatus and method for treating a film such as an interlayer insulating film coated on a substrate such as a semiconductor wafer.

2. Description of the Related Art

In the manufacturing process of a semiconductor device, a dielectric film such as an interlayer insulating film is spin-coated on a semiconductor wafer by, for example, the sol-gel method, the silk method, the speed film method or the Fox method, and is applied a chemical treatment, or a heat treatment so as to form a desired film. For example, in the sol-gel method, a solution wherein a colloid of tetraethoxysilane (TEOS) is dispersed in an organic solvent such as an ethanol is coated on a surface of a semiconductor wafer, made to be a gel, and dried so as to obtain a silicon oxide film.

Although the wafer is heated for promoting a gelation of the coated solution for a mass production, the gel film lacks in uniformity due to an active evaporation of the organic solvent. Therefore, it is being studied how the solution of TEOS is made to be the gel in an atmosphere of ammonia (NH₃) gas including a water vapor at the room temperature.

FIG. 7 is a conceptual illustration of a conventional gelation apparatus using the ammonia gas including the water vapor, wherein a dry ammonia gas from a not-shown supply source is introduced through a mass flow meter 91 into aqueous ammonia (NH₄OH) 92 in a bubbler 93, thereby introducing NH₃/H₂O gas from the bubbler 93 into a chamber 94 wherein the wafer W coated with the TEOS solution is placed. The chamber 94 is exhausted, under a control of a pressure control valve 95. However, if the aqueous ammonia 92 in the bubbler 93 is such one on the market that the ammonia concentration is not saturated, it takes some time for the gas concentration to become stationary. During that period of time, the gelation treatment can not be started, thereby lowering the productivity. Further, it is difficult to determine whether the ammonia concentration in water becomes stationary. Further, the aqueous ammonia 92 in the bubbler 93 decreases gradually, as the gelation of the coated film on the wafer W are repeated. Here, if the aqueous ammonia wherein the ammonia concentration is not saturated is added into the bubbler 93, the ammonia concentration is changed again, and a quantity of the ammonia gas introduced from the bubbler 93 into the chamber 94 is changed.

Further, as the semiconductor devices are being highly integrated recently, it is desired that the uniformity of the interlayer insulating film is strictly required and the above-mentioned gelation treatment is required to be controlled more precisely.

### BRIEF SUMMARY OF THE INVENTION

An object of the present invention is to provide an apparatus and method for stabilizing and controlling a content of a treatment gas supplied into a chamber for executing a treatment of a coated film.

The film treatment apparatus of the present invention, wherein a film of a coating solution coated on a substrate is gelatinized by using at least a second gas including a prescribed concentration of a vapor of prescribed solvent and a first gas, which comprises:

a chamber for placing said substrate coated with said film;

a first mass flow controller for supplying said chamber with said first gas;

a second mass flow controller for supplying said chamber with said second gas.

Further, the film treatment method of the present invention for gelatinizing a film of a coating solution coated on a substrate by using at least a second gas including a prescribed concentration of a vapor of prescribed solvent and a first gas, which comprises the steps of:

a first step for forming said film of a coating solution on said substrate;

a second step for transporting said substrate with said film into a treatment chamber; and

a third step for treating said film by supplying said treatment chamber with said first and second gases each of which flow is controlled by a respective mass flow controller.

Further, the film treatment method of the present invention for gelatinizing a film of a coating solution coated on a substrate by using at least a second gas including a prescribed concentration of a vapor of prescribed solvent and a first gas, which comprises the steps of:

a first step for forming said film of a coating solution on said substrate in an atmosphere of said second gas;

a second step for transporting said substrate with said film into a treatment chamber; and

a third step for treating said film by supplying said treatment chamber with said first gas through a mass flow controller and supplying said treatment chamber with said second gas.

According to the present invention, a film productivity of the coated film is improved, due to a stable supply of a treatment gas of a prescribed composition into a treatment chamber, comparing with a conventional gas supply wherein it takes a time for a bubbler to stabilize the gas composition. Further, quality and reliability of the coated film are improved due to a stable treatment film treatment in a stable and constant atmosphere. Further, a film treatment system as a whole is simplified by sharing an atmosphere control mechanism for other treatment unit such as a spin coating unit.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detail description of the preferred embodiments given below, serve to explain the principles of the invention.

FIG. 1 is a top view of the spin on dielectric (SOD) system.

FIG. 2 is a front view of the SOD system.

FIG. 3 is another front view of the SOD system.

FIG. 4 is a cross sectional view of the aging unit (DAC).

FIG. 5 is a cross sectional view of another DAC.

FIG. 6 is a cross sectional view of still another DAC.

FIG. 7 is an illustration of a conventional aging unit.

### DETAILED DESCRIPTION OF THE INVENTION

The spin on dielectric (SOD) system is used for coating an interlayer insulating film. First, the SOD system including a plurality of aging units (DAC) is explained.

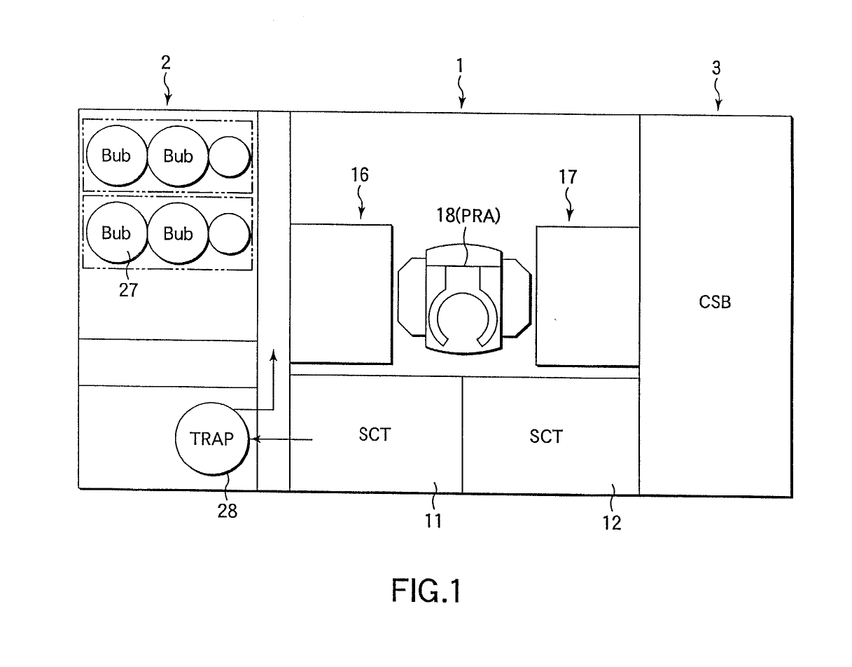

As shown in FIG. 1, the SOD system comprises a process section 1, a side cabinet 2, and a carrier station (CSB) 3. Coating process units (SCT) 11, 12 are arranged in an upper portion on the front side of the process section 1. Bubbler (Bub) 27 for supplying a chemical liquid and a trap (TRAP) 28 for cleaning the exhaust gas are arranged in the rear top side of the side cabinet 2. Process unit groups 16, 17 are arranged in the central portion of the process section 1, and a wafer transport mechanism (PRA) 18 for transporting a semiconductor wafer W is vertically movable between these process unit groups 16 and 17.

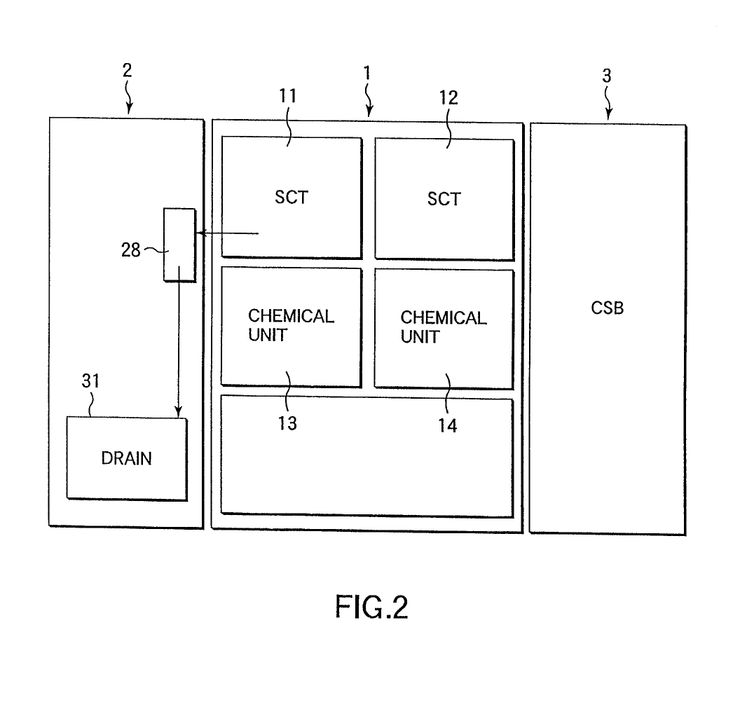

As shown in FIG. 2, at the lower stair of the side cabinet 2, a power supply source (not shown in FIG. 2), a chemical liquid chamber (not shown in FIG. 2) for storing a chemical liquid such as hexamethyl disilane (HMDS) and a gas such as an ammonia gas (NH₃), and a drain 31 for discharging waste liquids used in the SOD system are arranged below the bubbler (Bub) 27. Chemical units 13, 14 are arranged below the coating process units (SCT) 11, 12, respectively.

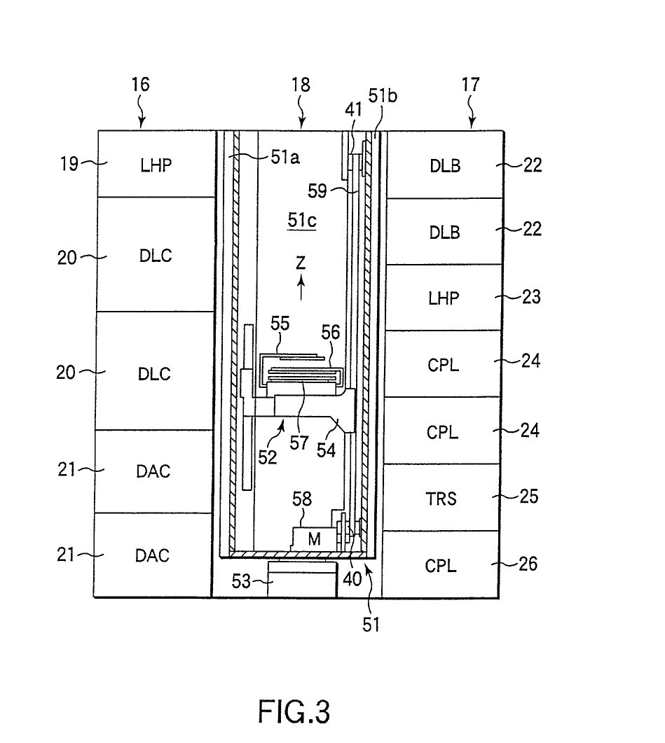

As shown in FIG. 3, the wafer transport mechanism (PRA) 18 includes a cylindrical support body 51 extending in a Z-direction and having vertical walls 51a, 51b and a side surface open portion 51c positioned between these vertical walls 51a and 51b, and a wafer transfer body 52 arranged inside the cylindrical support body 51 and vertically movable in the Z direction along the cylindrical support body 51. The cylindrical support body 51 can be rotated by the rotary driving force of a motor 53. In accordance with rotation of the cylindrical support body 51, the wafer transfer body 52 is also rotated.

The wafer transfer body 52 includes a transfer base 54, and three wafer transport arms 55, 56, 57 movable back and forth along the transfer base 54. The wafer transport arms 55, 56, 57 are of sizes capable of passing through the side surface open portion 51c of the cylindrical support body 51. These wafer transport arms 55, 56, 57 can be independently moved back and forth by a motor and a belt mechanism arranged within the transfer base 54. The wafer transfer body 52 can be moved in the vertical direction by driving a belt 59 by a motor 58. Further, a reference numeral 40 shown in FIG. 3 denotes a driving pulley, and a reference numeral 41 denotes a driven pulley.

The process unit group 16 on the left hand side comprises a hot plate unit (LHP) for a low temperature, two dielectric low oxygen controlled cure units (DLC) 20, and two aging units (DAC) 21, which are stacked one upon the other as viewed from the upper side. On the other hand, the process unit group 17 on the right hand side includes two dielectric low oxygen controlled baking units (DLB) 22, a low temperature hot plate unit (LHP) 23, two cooling plate units (CPL) 24, a delivery unit (TRS) 25, and a cooling plate unit (CPL) 26, which are stacked one upon the other as viewed from the upper side. Here, the delivery unit (TRS) 25 also can functions as the cooling plate unit.

When an interlayer insulating film or the like is formed on a wafer W by means of, for example, the solgel method by using the SOD system described above, the wafer W is transported through the cooling plate unit (CPL) 24 or 26, the coating process unit (SCT) 11 or 12, the aging unit (DAC) 21, the hot plate unit (LHP) 19 or 23, and the DLB unit 22, in that order for applying predetermined treatments to the wafer W.

When an interlayer insulating film or the like is formed on the wafer W by means of the silk method or the speed film method, the wafer W is transported through the cooling plate unit (CPL) 24 or 26, the coating process unit (SCT) 11 or 12 (for coating the adhesion promoter), the hot plate unit (LHP) 19 or 23, the coating process unit (SCT) 11 or 12 (for coating the chemical liquid for forming the film), the hot plate unit (LHP) 19 or 23, the DLB unit 22, and the DLC unit 20, in that order.

Further, when an interlayer insulating film or the like is formed on the wafer W by the Fox method, the wafer W is transported through the cooling plate unit (CPL) 24 or 26, the coating process unit (SCT) 11 or 12, the low temperature hot plate unit (LHP) 19, the DLB unit 22 and the DLC unit 20, in that order.

Here, film materials are not limited to the above examples. Various organic, inorganic or hybrid materials are used.

Next, the aging unit (DAC) 21 is explained, when NH₃ gas (first gas) and H₂O/N₂ gas (second gas) ate used for the sol-gel method.

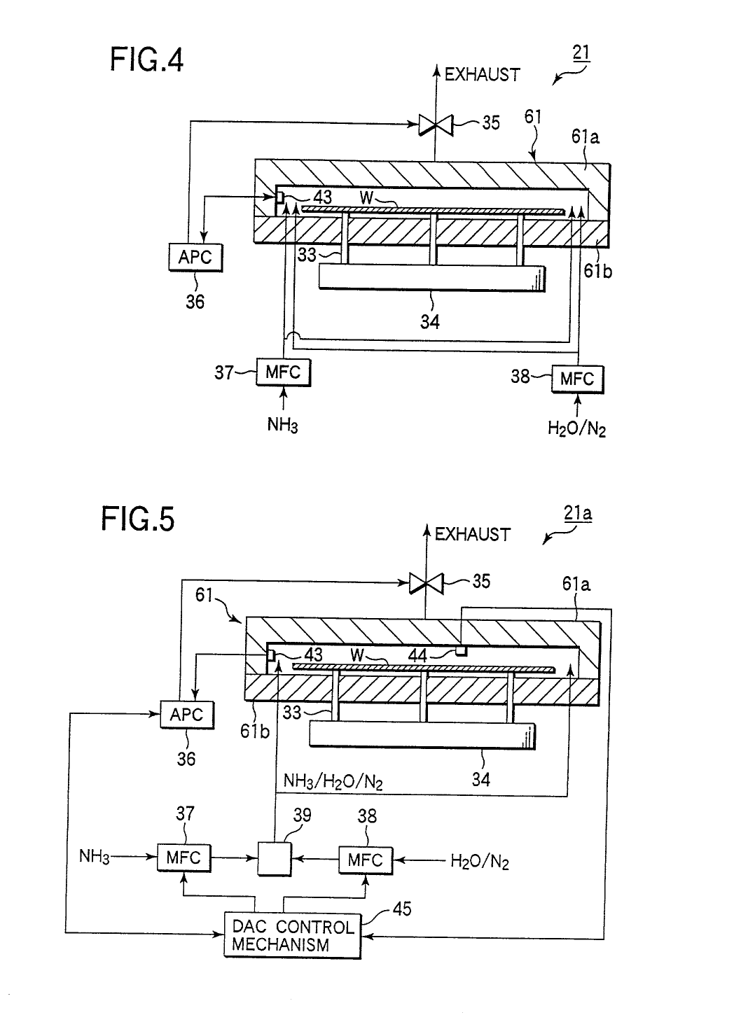

FIG. 4 is a cross sectional view of an aging unit (DAC) 21. The aging unit (DAC) 21 comprises: a chamber 61 for receiving the wafer W; a pressure sensor 43 for detecting a pressure in the chamber 61; an exhaust valve 35 for controlling the gas exhaust from the chamber 61 to the outside; an automatic pressure controller (APC) 36 for controlling a throttle of the valve 35, on the basis of the pressure measured by the pressure sensor 43; a mass flow controller (MFC) 37 for controlling an amount of the NH₃ gas flowing into the chamber 61; and a mass flow controller (MFC) 38 for controlling an amount of the H₂O/N₂ gas flowing into the chamber 61.

The chamber 61 comprises: a table 61b; a cover 61a for covering over the table 61b; pins 33 passing through the table 61b and supporting the wafer W; and up down mechanism 34 for moving up and down the pins 33. When the cover 61 a is elevated and the pins 33 are held at a prescribed height, the wafer transport arm 55 holding the wafer W is moved over the table 61b, thereby transporting the wafer W from the wafer transport arm 55 to the pins 33. Then, the pins 33 is moved down in order to place the wafer W on not-shown support pins on the table 61b. Then, the cover 61a is moved down in order to form a treatment space of the chamber 61. The reverse order actions are made for transporting the wafer out of the chamber 61. The amount of the NH₃ gas and the H₂O/N₂ gas supplied into the chamber 61 are controlled at prescribed amounts, by the mass flow controllers (MFC) 37 and 38, respectively.

Pure and dry NH₃ gas is used for the NH₃ gas, while the H₂O/N₂ gas is made by such a manner that a prescribed amount of a dry N₂ gas flow is introduced into a gas tube with an evaporation room for evaporating a prescribed amount of water. Here, the H₂O/N₂ gas is prevented from a dew condensation in the gas tube on the way from the evaporation room to the chamber 61.

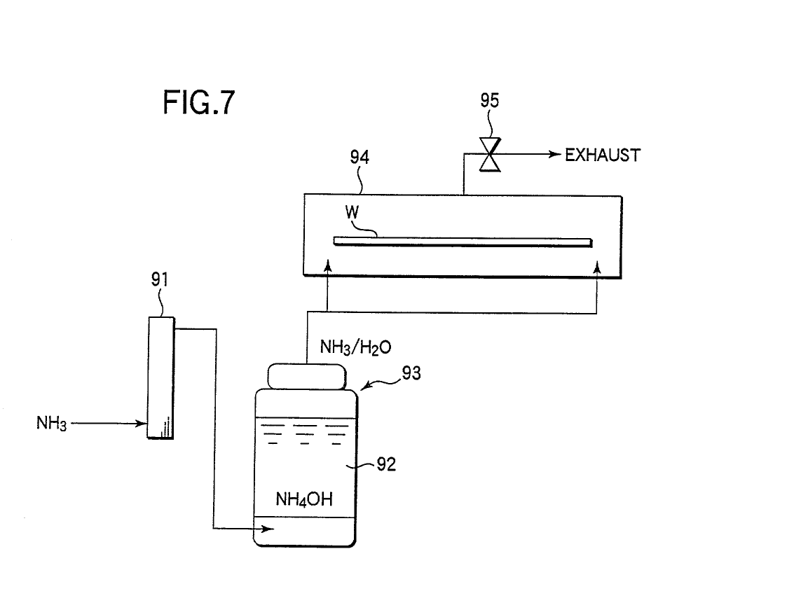

Further, the ratio of the NH₃ content to the water content supplied into the chamber 61 is kept constant at a prescribed level even at the beginning when the supply of the NH₃ gas and the H₂O/N₂ gas into the chamber 61 is started. Thus, the gas flow into the chamber 61 is always kept constant. However, when the pressure in the chamber 61 is changed, the pressure change is detected by the pressure sensor 43 and the measured signal is transmitted to the automatic pressure controller (APC) 36, thereby controlling the throttle of the exhaust valve 35 and keeping the pressure in the chamber 61 constant. When the NH₃ gas is humidified by passing the NH₃ gas through the bubbler 93 as shown in FIG. 7, it takes a time period to stabilize the humidity and pressure of the NH₃ gas supplied from the bubbler 93. However, it is possible for the aging unit (DAC) 21 to start, without standing by during the waiting time period, the treatment of the wafer W at the beginning when the supply of he NH₃ gas and the H₂O/N₂ gas into the chamber 61 is started. Therefore, the wafer W is processed efficiently.

FIG. 5 is a cross sectional view of another aging unit (DAC) 21a. The aging unit (DAC) 21a further comprises, comparing with the aging unit as shown in FIG. 4: a DAC control mechanism 45 for controlling the mass flow controllers 37 and 38 and the automatic pressure controller (APC) 36; a mixer 39 for mixing outside of the chamber 61 the NH₃ gas outputted from the mass flow controller 37 and the H₂O/N₂ gas outputted from the mass flow controller 38; and an ammonia concentration sensor 44 for detecting the ammonia concentration in the chamber 61.

The amount of the NH₃ gas supplied into the chamber 61 is controlled on the basis of the measurement result of the ammonia concentration sensor 44 so as to keep a prescribed NH₃ concentration in the chamber 61. The DAC control mechanism 45 controls the mass flow controller (MFC) 37 in order to maintain the ratio of the H₂O component to the NH₂ component at a constant level.

If the gas flow into the chamber 61 is changed under the controls of the mass flow controllers (MFC) 37 and 38, the pressure in the chamber 61 is in general changed. Therefore, the automatic pressure controller (APC) 36 controls the throttle of the exhaust valve 35 in order to indicate a prescribed pressure in the chamber 61. Thus, the coated film is of a high quality due to a stable treatment in an atmosphere with a prescribed composition and pressure in the chamber of the aging unit (DAC) 21a.

Further, it is easy to change the treatment conditions by using the aging unit (DAC) 21a. For example, the new conditions such as the ammonia concentration in the chamber 61 or the total pressure in the chamber 61 may be inputted into the DAC control mechanism 45, in accordance with a kind of the coated film. In accordance with the inputted conditions, the mass flow controllers (MFC) 37 and 38 are controlled so as to satisfy the inputted conditions within the allowable ranges of the NH₃ gas flow, H₂O/N₂ gas flow or the total gas flow, and the exhaust valve 35 is controlled. Thus, the desired treatment conditioned is obtained rapidly.

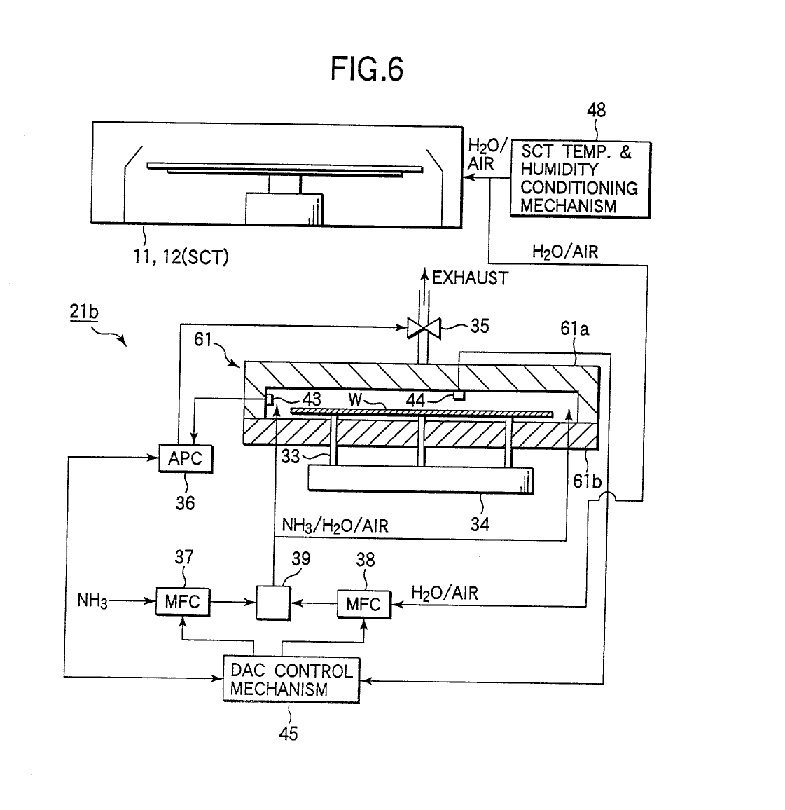

FIG. 6 is an illustration of still another aging unit (DAC) 21b which is different from the aging unit (DAC) 21a in such a point that the SCT temperature and humidity control mechanism 48 for the coating process unit (SCT) 11 or 12 is utilized in order to supply H₂O/N₂ gas.

The SCT temperature and humidity control mechanism 48 in the coating process unit (SCT) 11 or 12 for coating a prescribed film on the wafer W supplies the coating process unit (SCT) unit 11 or 12 with a humidity controlled air of 40 to 60% humidity. The humidity controlled air from the SCT temperature and humidity control mechanism 48 is introduced into a mixer 39 through the mass flow controller (MFC) 38 for mixing the NH₃ gas from the mass flow controller (MFC) 38 with the conditioned air from the mass flow controller (MFC) 38, thereby supplying the chamber 61 with a gas of which component ratio of NH₃ to H₂O is a prescribed value.

Here, the amount of the conditioned air to the aging unit (DAC) 21b may be controlled by the SCT temperature and humidity control mechanism 48 without employing the mass flow controller (MFC) 37, thereby simplifying the aging unit (DAC). Further, a humidity sensor may be employed in addition with the HN₃ concentration sensor 44. The output from the humidity sensor is inputted into the DAC control mechanism for controlling the mass flow controllers (MFC) 37 and 38 in order to keep the NH₃ concentration and humidity constant in the chamber 61 of the aging unit (DAC) 21a or 21b.

Next, an exemplary process is explained concerning a formation of an interlayer insulating film by the solgel method in the aging unit (DAC) 21a. Here, the coating solution contains colloids or particles of metal alkoxide TEOS dispersed in a solvent of ethylene glycol, ethanol, water and a very small amount of hydrochloric acid.

First, the wafer W is introduced into the coating process unit (SCT) 11 or 12, for example, through cooling plate unit (CPL) 24 or 26 after completing a prior treatment. The humidity in the coating process unit (SCT) 11 or 12 is kept at a prescribed level in order to prevent a rapid drying of the coating solution on the wafer W and to keep constant the vapor components in the coating solution except the water.

A prescribed amount of the coating solution is dropped on the wafer W held on a spin chuck which is then rotated, thereby forming a coated film. Then, the wafer W is transported by the wafer transport mechanism PRA 18 to the aging unit (DAC) 21a.

The wafer W is placed on the table 61b in the chamber 61 in the aging unit (DAC) 21a, where the coated film on the wafer W is gelatinized in an mixed gas atmosphere from the mixer 39 for mixing the NH₃ gas controlled by the mass flow controller (MFC) 37 and the H₂O/N₂ gas controlled by the mass flow controller (MFC) 38.

The pressure in the chamber 61 during the gelation is always monitored by the pressure sensor 43 in order to keep the pressure constant by controlling the throttle of the exhaust valve 35 by using the automatic pressure controller (APC) 36. Further, DAC control mechanism 45 controls the mass flow controllers (MFC) 37 and 38 in order to control the NH3 and H₂O/N₂, respectively, thereby keeping constant the NH₃ concentration into the chamber 61. Thus, as the atmosphere is stabilized during the gelation, variations in the gelation reaction every wafer W are suppressed, the qualities of the coated wafers are kept constant and high. After completing the gelation for a prescribed time period in the aging unit (DAC) 21a, the solvent is evaporated at a relatively low temperature in a low temperature hot plate 19 or 23. The wafer W is then baked in the DLB 22 at a temperature higher than that in the hot plate unit (LHP) 19 or 23, thereby finally forming the interlayer insulating film of silicon oxide.

Although the embodiments of the present invention are explained above, the present invention is not limited those embodiments.

For example, the present invention is applied, in general, when a solvent vapor of a gas is water, while another gas is soluble in water. Concretely, one of the gas may be H₂O/N₂ gas, while another gas may be CO₂.

Further, the present invention is also applied, when a solvent vapor of a gas is an organic solvent vapor, while another gas is soluble in that organic solvent, although one of the components of above-mentioned another gas may not always be soluble in that organic solvent. The present invention is useful, when a treatment gas with more precise controlled concentrations are required to be stably supplied.

Further, three or more kinds of gases may be mixed, although two gases are mixed in the above-explained embodiments. Further, although, in FIG. 6, an atmosphere controlling gas of the coating process unit (SCT) 11 or 12 is introduced into the aging unit (DAC) 21b as a treatment gas, another unit of the SOD system which treats a treatment gas capable of introducing into the aging unit (DAC) 21b may feed the treatment gas to the aging unit (DAC) 21b, if presence.

Further, substrates other than the semiconductor wafer, such as that for liquid crystal display (LCD) substrate may be used.

The embodiments described above are simply intended to clarify the technical concept of the present invention. Of course, the present invention should not be limited to the embodiments described above in interpreting the technical scope of the present invention. The present invention can be worked in variously modified fashions within the spirit of the present invention and within the scope defined by the accompanying claims.

What is claimed is:

1. A film treatment apparatus, wherein a film of a coating solution coated on a substrate is gelatinized by using at least a second gas including a prescribed concentration of a vapor of prescribed solvent and a first gas, which comprises:
a chamber for placing said substrate coated with said film;
a first mass flow controller for supplying said chamber with said first gas;
a second mass flow controller for supplying said chamber with said second gas.

2. The film treatment apparatus according to claim 1, which further comprises:
exhaust means for exhausting said chamber; and
a chamber pressure control mechanism for detecting a pressure in said chamber, operating said exhaust means and controlling said pressure.

3. The film treatment apparatus according to claim 1, which further comprises:
a concentration sensor for measuring a concentration of said first gas in said chamber;
a pressure sensor for measuring a pressure in said chamber;
exhaust means for exhausting said chamber;
a chamber pressure control mechanism for operating said exhaust means on the basis of a measurement signal from said pressure sensor and for controlling said pressure; and
a gas composition control mechanism for controlling said first or second mass flow controller on the basis of a measurement signal from said concentration sensor thereby keeping constant said concentration of said first gas.

4. The film treatment apparatus according to claim 3, which further comprises a coating unit for coating a coating solution on a substrate and forming a film on said substrate.

5. The film treatment apparatus according to claim 3, wherein said second mass flow controller controls said second gas.

6. The film treatment apparatus according to claim 1, which further comprises a mixer for mixing said first and second gases, wherein the mixed gas from said mixer is supplied into said chamber.

7. The film treatment apparatus according to claim 3, wherein said chamber pressure control mechanism controls said pressure by controlling a throttle of an exhaust valve of said exhaust mechanism on the basis of a measurement signal from said pressure sensor.

8. A film treatment method for gelatinizing a film of a coating solution coated on a substrate by using at least a second gas including a prescribed concentration of a vapor of prescribed solvent and a first gas, which comprises the steps of:
a first step for forming said film of a coating solution on said substrate;
a second step for transporting said substrate with said film into a treatment chamber; and
a third step for treating said film by supplying said treatment chamber with said first and second gases each of which flow is controlled by a respective mass flow controller.

9. A film treatment method for gelatinizing a film of a coating solution coated on a substrate by using at least a second gas including a prescribed concentration of a vapor of prescribed solvent and a first gas, which comprises the steps of:
a first step for forming said film of a coating solution on said substrate in an atmosphere of said second gas;
a second step for transporting said substrate with said film into a treatment chamber; and
a third step for treating said film by supplying said treatment chamber with said first gas through a mass flow controller and supplying said treatment chamber with said second gas.
